(19) United States
(12) Patent Application Publication
(10) Pub. No.: US 2015/0083263 A1
(43) Pub. Date: Mar. 26, 2015

(54) FLEXIBLE WATER PIPE

(71) Applicant: Jinhua Haoquang Co., Ltd., Zhejiang (CN)

(72) Inventor: Ke-Hao Pei, Zhejiang (CN)

(73) Assignee: Jinhua Haoquang Co., Ltd., Zhejiang (CN)

(21) Appl. No.: 14/262,087

(22) Filed: Apr. 25, 2014

(30) Foreign Application Priority Data
Apr. 25, 2013 (CN) 201320212087

(51) Int. Cl. F16L 11/04

(52) U.S. Cl. CPC F16L 11/04
USPC 138/119

(57) ABSTRACT

A flexible water pipe, including: an inner pipe, which can extend or contract when water-filling or dewatering in the flexible water pipe; an outer pipe, which can unfold or wrinkle when water-filling or dewatering in the flexible water pipe; several rings arranged outside the inner pipe; a joint in inflow side, which is used to fasten the inner and outer pipes in inflow side; and a joint in outflow side, which is used to fasten the inner and outer pipes in outflow side; wherein, the outer pipe is arranged outside the inner pipe and the ring.

### CROSS REFERENCE TO RELATED APPLICATION

This application claims priority benefit from foreign patent application CN 201320212087 (published as CN 203215120 U), filed Apr. 25, 2013, which is incorporated herein in its entirety.

### TECHNICAL FIELD

The present Utility Model relates to gardening tools, in particular, to a water pipe.

### BACKGROUND ART

In prior art, the Chinese Utility Model Patent of Application No. 201220069023.4 discloses a flexible water pipe including a tube and a connection installed in both two ends of the tube. The tube includes a flexible pipe and a sheath, wherein the sheath covers the flexible pipe and its length is longer than that of the flexible pipe, with two ends of both the sheath and the flexible pipe connecting with each other. The connection includes a reducer union, a connecting nipple, a cushion cover and a metal locking piece covering the lateral of cushion cover, wherein the connecting nipple and the reducer union are linked together, the external bore diameter of water stoma in reducer union is larger than inner bore diameter of water stoma, the terminal of flexible pipe covers lateral wall of interior in reducer union, both of the cushion cover and the metal locking piece cover the flexible pipe, and the metal locking piece locks the cushion cover and makes the reducer union in cushion cover and the flexible pipe firmly compressed and fixed.

The flexible pipe suffers the hydraulic pressure of water pipe when water-filling in the water pipe, expands radially and extends along the length direction at the same time, leading to gradual unfolding of wrinkles in the sheath and making the length of water pipe gradually increased. When the sheath made of non-elastic materials is fully unfolded, it imposes restrictions on further extending of the flexible pipe along the radial and length directions, making said water pipe reach maximum diameter and length. When the water in the water pipe is gradually emptying, the flexible pipe becomes contracted along both the radial and length directions under the contractility of its elastic materials. The sheath randomly produces wrinkles until the water is completely emptying, and at that time the flexible pipe gets contracted to its minimum length. The water pipe, in practical daily use, possesses the technical advantage of automatic flexibility and light weight.

However, it can be found in daily use that during the process of extending and contracting in the water pipe, due to the completely separated status between the sheath and the flexible pipe, it is easy to produce extrusion and friction between the sheath and the flexible pipe. This phenomenon makes non-negligible damage to the flexible pipe under the circumstance that the yield of water remaining in water pipe is still larger and the thickness of pipe wall in flexible pipe is thinner. In particular, if the internal face of sheath is provided with burrs, severe damage will be made to the flexible pipe, thus reducing the strength and service life of water pipe.

### DISCLOSURE OF THE UTILITY MODEL

In order to solve the above-mentioned technical problem, the present utility model discloses a flexible water pipe, of which the technical solution is carried out as follows:

A flexible water pipe, including: an inner pipe, which can extend or contract when water-filling or dewatering in said flexible water pipe; an outer pipe, which can unfold or wrinkle when water-filling or dewatering in said flexible water pipe; several rings arranged outside said inner pipe; a joint in inflow side, which is used to fasten the inner and outer pipes in inflow side; and a joint in outflow side, which is used to fasten the inner and outer pipes in outflow side; wherein, the outer pipe is arranged outside the inner pipe and the ring.

Furthermore, said joint in outflow side is a valve or nozzle.

Furthermore, said ring is fixed joint with said inner pipe.

Furthermore, said ring is fixed joint with said outer pipe.

Furthermore, the space between adjacent said rings is no lower than 300 mm, under the maximum length of said flexible water pipe.

Furthermore, said ring is split ring.

Furthermore, said ring is 2-8 cm in width.

Furthermore, said ring includes a gradually expanding section located in two sides of said ring.

Furthermore, inner wall of said outer pipe includes a lubricating layer.

The technical solution in the present utility model can be carried out to solve the technical problem in prior art that extrusion and friction occur between the inner and outer pipes of flexible water pipe and destroy the inner pipe. Implementation of the technical solution in the present utility model can achieve the technical effect of protecting the inner pipe and increasing service life through setting several rings between said inner and outer pipes so as to reduce contact between said inner and outer pipes.

### BRIEF DESCRIPTION OF DRAWINGS

For more clearly explain embodiments of present utility model or technical solution in prior art, brief description is made to drawings necessarily used in descriptions for embodiments or prior art as follows. Obviously, the drawing in the following description is only one embodiment of present utility model and it is able for the ordinary skilled in this art to obtain other drawings according to these drawings, without creative labor.

FIG. 1 is a perspective view of structure of flexible water pipe according to one embodiment of present utility model;

FIG. 2 is a structural view of ring according to one preferred embodiment of present utility model;

FIG. 3 is a structural view of ring according to another preferred embodiment of present utility model;

Various reference numerals are indicated in the above-mentioned drawings, respectively:

1—inner pipe; 2—outer pipe; 3—ring; 4—joint in inflow side; 5—joint in outflow side.

### BEST MODE FOR CARRYING OUT THE UTILITY MODEL

The technical solution of embodiment in the present utility model will be clearly and comprehensively described with reference to the accompanying drawings as follows, and obviously, the described embodiment is only a part of embodiments of the present utility model, instead of all the ones. Based on the embodiments of the present utility model, any other embodiments obtained from the ordinary skilled in this art without creative labor, fall into the scope claimed by the present utility model.

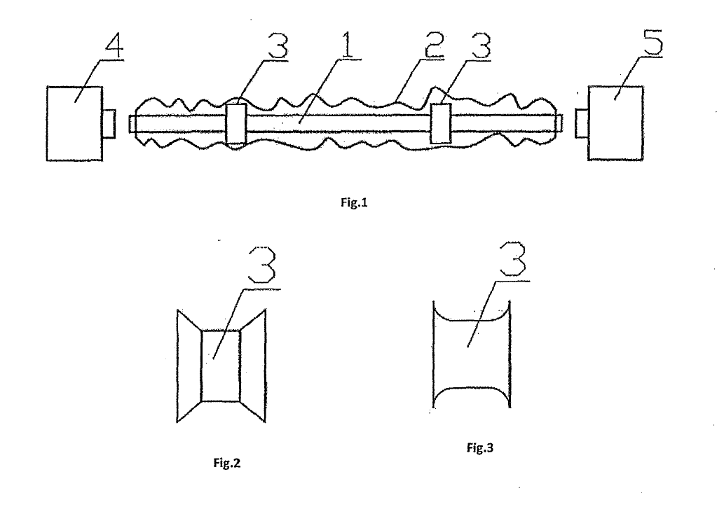

According to one embodiment in the present utility model, a flexible water pipe, as FIG. 1 indicated, includes: an inner pipe 1, which can extend or contract when water-filling or dewatering in said flexible water pipe; an outer pipe 2, which can unfold or wrinkle when water-filling or dewatering in said flexible water pipe; several rings 3 arranged outside said inner pipe 1; a joint in inflow side 4, which is used to fasten the inner and outer pipes in inflow side; and a joint in outflow side 5, which is used to fasten the inner and outer pipes in outflow side; wherein, the outer pipe 2 is arranged outside the inner pipe 1 and the ring 3.

In the embodiment, it is different from the prior art in that said ring 3 is arranged between said inner pipe 1 and said outer pipe 2. Said ring 3 will separate said inner pipe 1 from said outer pipe 2 in some positions, avoiding and reducing extrusion occurred by said inner pipe 1 and said outer pipe 2 in the positions of said ring 3 and its adjacency. Furthermore, due to reduction in extrusion, when friction occurs between said inner pipe 1 and said outer pipe 2, the frictional force will decrease. Therefore, the technical effect for protecting said inner pipe 1 and increasing service life can be achieved through setting said ring 3. Because the structure of the joint in inflow side 4 or joint in outflow side 5 does not belong to the technical innovation point of the present utility model and various designs and structures for joint have been disclosed in the prior art, the present utility model omits the same hereby. The skilled in this art has the ability to adopt all kinds of joints in the prior art to combine with the technology in the present utility model, to acquire various different embodiments without breaking away from the scope claimed by the present utility model.

In the preferred embodiment, said joint in outflow side 5 is a valve or nozzle. Said joint in outflow side is directly set as a valve or nozzle, thereby avoiding the connection to a separate valve or nozzle through the joint of male thread or female thread and being convenient in use.

In the preferred embodiment, said ring 3 is fixed joint with said inner pipe 1. Fastening the relative position between said ring 3 and said inner pipe 1 with glue can prevent said ring 3 from changing position along the length direction. Said ring 3 divides said inner pipe 1 into several separate-flexible sections. The flexible water pipe in the prior art is out of controllability in the process of water-filling and dewatering, and completely depends on the flexibility of natural materials in said inner pipe 1. If different-level damages are made to materials of said inner pipe in different positions, difference in elasticity will produce, leading to different shrinkage degrees in different positions of flexible pipeline and increasing attrition. In the preferred embodiment, when water-filling/dewatering in said inner pipe 1, people could observe the extending/contract for materials of said inner pipe in different sections and make man-made or automatic adjustment according to different need, so as to reduce attrition of said flexible water pipe. Obviously, the use of glue will not be regarded as a limitation to the preferred technical solution, and the skilled in this art, on the basis of non-creative labor, can apply various fixed mode in the prior art such as adhesive tape, ribbon, snap joint and so on, to form permanent connection between said inner pipe 1 and said ring 3.

In the preferred embodiment, said ring 3 is fixed joint with said outer pipe 2. The relative positions among said ring 3 and said inner pipe 1 as well as said outer pipe 2 can be fastened with glue. The flexible water pipe of prior art probably produces wrinkle to varying degrees in different positions along the length direction in the process of contraction. When the wrinkle of said outer pipe 1 is of uniformity, the extrusion force and frictional force between said inner pipe 1 and said outer pipe 2 are both smaller. When the wrinkle is of non-uniformity, more extrusion force will occur in mainly wrinkled position between said inner pipe 1 and said outer pipe 2, and at the same time the relative position between said inner pipe 1 and said outer pipe 2 will move along the length direction, so as to produce sliding friction and damage said inner pipe 1. When the relative positions among said ring 3 and said inner pipe 1 as well as said outer pipe 2 are fixed, said flexible water pipe will be distinguished as several separate-flexible sections to make the wrinkle of said outer pipe more uniform in the process of contraction. In addition, even though differences in the degree of wrinkle exist in different sections, the degree for the relative position is less, and thus the destruction to said inner pipe 1 by sliding friction is less too. Obviously, the use of glue will not be regarded as a limitation to the preferred technical solution, and the skilled in this art, on the basis of non-creative labor, can apply various fixed mode in the prior art such as adhesive tape, ribbon, snap joint and so on, to form permanent connection between said outer pipe 2 and said ring 3.

Preferably, in the maximal length of said flexible water pipe, the space between adjacent said rings 3 is no less than 300 mm. The arrangement of said rings 3 inevitably imposes restrictions on flexibility of said inner pipe in partial position, and in the maximal length of said flexible water pipe, the space between adjacent said rings 3 is no less than 300 mm, namely, when magnification ratio of said flexible water pipe is 3, in the minimum length of said flexible water pipe, the space between adjacent said rings 3 is no less than 100 mm.

Preferably, said ring is split ring. Therefore, it is convenient in manufacture and less in labor cost.

Preferably, said ring is 2-8 cm in width. If the width of said ring is less than 2 cm, when said rings 3 imposes restrictions on the extension of said inner pipe 1 in the radial direction, too much accumulated pressure will probably produce on the wall surface of said inner pipe 1, forming marks of rein and damaging said inner pipe 1. If the width of said ring 3 is greater than 8 cm, restrictions will be imposed on the extension of said inner pipe 1 as a whole, making the whole performance of said flexible water pipe disadvantageous.

In the preferred embodiment, said ring 3 includes a gradually expanding section located in two sides of said ring. Due to the restrictions on the radial extension of said inner pipe 1 by said ring 3, in order to avoid appearing of marks of rein on boundary of said ring 3 in said inner pipe 1 and damaging said inner pipe, the design of gradually expanding section can be used, as shown in FIGS. 2 and 3. Obviously, the skilled in this art can use designs of said ring 3 in different shapes to achieve the same or similar technical effect as the present utility model, without breaking away from the scope claimed by the present utility model.

In the preferred embodiment, inner wall of said outer pipe 2 includes a lubricating layer. In order to further decrease the sliding friction force between said outer pipe 2 and said inner pipe 1, a lubricating layer can be coated inside said outer pipe 2 to further decrease the sliding friction force and protect said inner pipe 1.

It shall be noted that, the above-mentioned statements are only nothing more than preferable embodiments, instead of a limitation to the present utility model, and any other modifications, equivalent replacements and improvements within the essence and principle of the present utility model, shall be included within the scope claimed by the present utility model.

What is claimed is:

1. A flexible water pipe, including: an inner pipe, which can extend or contract when water-filling or dewatering in said flexible water pipe; an outer pipe, which can unfold or wrinkle when water-filling or dewatering in said flexible water pipe; several rings arranged outside said inner pipe; a joint in inflow side, which is used to fasten the inner and outer pipes in inflow side; and a joint in outflow side, which is used to fasten the inner and outer pipes in outflow side; wherein, the outer pipe is arranged outside the inner pipe and the ring.

2. The flexible water pipe of claim 1, wherein said joint in outflow side is a valve or nozzle.

3. The flexible water pipe of claim 1, wherein said ring is fixed joint with said inner pipe.

4. The flexible water pipe of claim 1, wherein said ring is fixed joint with said outer pipe.

5. The flexible water pipe of claim 3, wherein the space between adjacent said rings is no lower than 300 mm, under the maximum length of said flexible water pipe.

6. The flexible water pipe of claim 4, wherein said ring is split ring.

7. The flexible water pipe of claim 4, wherein said ring is 2-8 cm in width.

8. The flexible water pipe of claim 7, wherein said ring includes a gradually expanding section located in two sides of said ring.

9. The flexible water pipe of claim 4, wherein inner wall of said outer pipe includes a lubricating layer.

10. The flexible water pipe of claim 2, wherein said ring is fixed joint with said outer pipe.

11. The flexible water pipe of claim 10, wherein said ring is split ring.

12. The flexible water pipe of claim 10, wherein said ring is 2-8 cm in width.

13. The flexible water pipe of claim 12, wherein said ring includes a gradually expanding section located in two sides of said ring.

14. The flexible water pipe of claim 10, wherein inner wall of said outer pipe includes a lubricating layer.

15. The flexible water pipe of claim 5, wherein said ring is split ring.

16. The flexible water pipe of claim 5, wherein said ring is 2-8 cm in width.

17. The flexible water pipe of claim 16, wherein said ring includes a gradually expanding section located in two sides of said ring.

18. The flexible water pipe of claim 5, wherein inner wall of said outer pipe includes a lubricating layer.
